(19) United States
(12) Patent Application Publication
(10) Pub. No.: US 2025/0283503 A1
(43) Pub. Date: Sep. 11, 2025

(54) Fastening System

(71) Applicant: Illinois Tool Works Inc., Glenview, IL (US)

(72) Inventors: Ismael Fuentes, Sabadell (ES); David Fol, Barcelona (ES)

(21) Appl. No.: 19/071,217

(22) Filed: Mar. 5, 2025

(30) Foreign Application Priority Data
Mar. 6, 2024 (EP) 24161721.6
Feb. 7, 2025 (FR) 2501280

(51) Int. Cl. F16B 43/00; F16B 37/04

(52) U.S. Cl. CPC F16B 43/001; F16B 37/044

(57) ABSTRACT

A fastening system comprising a fastener and a cage and a sealing element. The fastener is enclosed and held by the cage. The sealing element arranged so that using the fastener places the sealing element in a sealing area between the cage and the fastener.

### RELATED APPLICATIONS

The present application claims the benefit of European Patent Application No. EP24161721.6, filed Mar. 6, 2024, and French Patent Application No. FR2501280, filed Feb. 7, 2025, each titled “Fastening System,” the contents of which are hereby incorporated by reference.

### BACKGROUND

The disclosure relates to a fastening system, in particular with an insert fastener, used in particular in the automotive field. Contrary to existing fasteners, the disclosure relates to an insert fastener with a seal protecting its various parts, and in particular the insert, against the intrusion of contaminants, fumes or liquids.

### SUMMARY

The present disclosure relates generally to a fastening system, substantially as illustrated by and described in connection with at least one of the figures, as set forth more completely in the claims. More particularly, to a fastening system with optimized sealing, in particular to protect its insert.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates the fastener in accordance with a first aspect in a partial cross-section.

FIG. 1b illustrates the fastener of FIG. 1a with an insert in a partial cross-section.

FIG. 1c illustrates the fastener of FIG. 1a as seen from the side with an insert.

FIG. 2a illustrates the fastener in accordance with a second aspect, in a partial cross-section.

FIG. 2b illustrates the fastener of FIG. 2a with an insert in a partial cross-section.

FIG. 2c illustrates the fastener of FIG. 2a as seen from the side with an insert.

FIG. 3a illustrates the fastener in accordance with a third aspect in a partial cross-section.

FIG. 3b illustrates the fastener of FIG. 3a with an insert in a partial cross-section.

FIG. 3c illustrates the fastener of FIG. 3a as seen from the side with an insert.

FIG. 4a illustrates the fastener in accordance with a fourth aspect, in a partial cross-section.

FIG. 4b illustrates the fastener of FIG. 4a with an insert in a partial cross-section.

FIG. 4c illustrates the fastener of FIG. 4a as seen from the side with an insert.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

In order to comply with current safety standards, the cab of a vehicle must be designed to withstand smoke ingress for a defined period. Many body-in-white fasteners are not fire-retardant. This can present a risk, especially as more and more vehicles are shifting to an electric drive system in which the batteries are often located on the vehicle's undercarriage in areas immediately below the driver/passenger cab.

Polymer sealants can be used, but these gaskets cannot be used in adjacent parts that are to be welded together, as the heat of the welding process can cause premature failure of such products. Fasteners designed to withstand high loads are often position-welded and are therefore not suitable for use with such polymer sealants.

The disclosure relates to a fastening system comprising a fastener and a cage, wherein the fastener is enclosed and held by the cage, and a sealing element is arranged so that using the fastener places the sealing element in a sealing area between the cage and the fastener.

For example, the sealing element also forms a seal around an insert that is placed in the fastener.

For example, the sealing element sealingly interferes with the fastener when the fastener is used.

The sealing element can be arranged to sealingly interfere between the fastener and the insert.

The sealing element can also comprise a soft cap.

The soft cap can be located on the sealing element and away from the cage.

For example, the sealing element is loosely connected to the cage and/or to the fastener.

For example, the sealing element is directly connected to the fastener and/or to the cage.

For example, the fastener, the cage and/or the sealing element are each made of a metal or comprise a metal. The metal can comprise copper, a copper alloy, aluminum and/or graphite.

For example, the sealing element is made of a metal with a reduced hardness compared to the metal used to make the fastener and/or the cage.

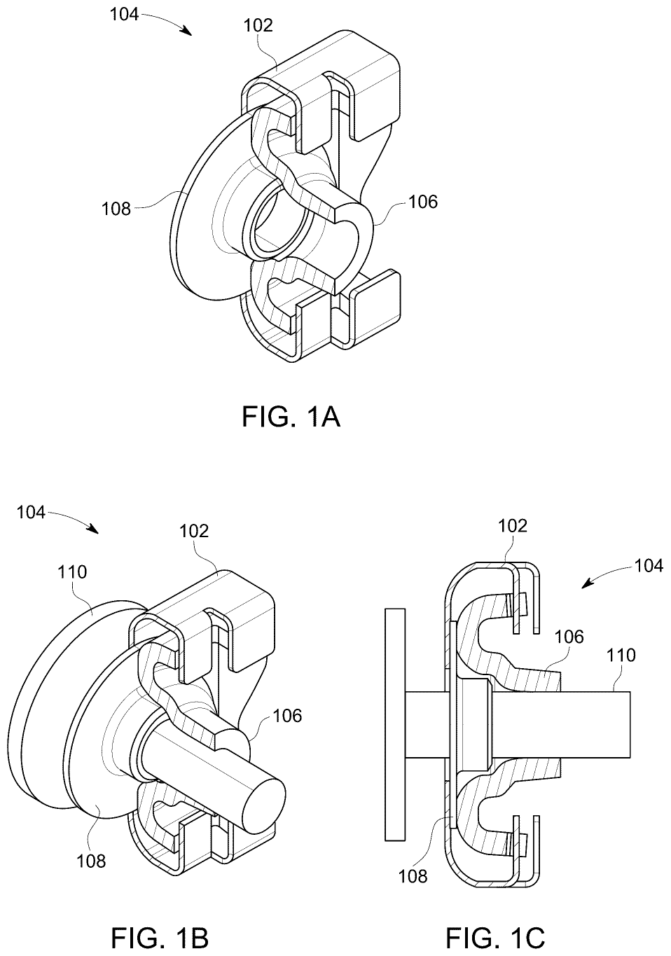

FIGS. 1a through 1c shows a fastening system 104 according to a first aspect. More specifically, FIG. 1a illustrates the fastener in accordance with a first aspect in a partial cross-section, while FIGS. 1b and 1c illustrate, respectively, the fastener with an insert in a partial cross-section and as seen from the side with an insert. A fastening system 104 comprises a cage 102 combined with a retained fastener 106. Such a fastener 106 can be moved relative to the cage 102, but only to a limited extent, such that the two parts cannot be completely separated. The sealing element 108 is loosely connected to the cage 102 and/or to the fastener 106. This arrangement is useful in manufacturing as tolerances can be eased while allowing for effective coupling via the fastening system 104.

The retracted fastening system 104 is designed to support high loads, such as the coupling of a seat rail inside a cab or the body in white of a vehicle. The fastening system 104 is generally made of a weldable metal such as steel. The fastener 106 held in the cage can be of the same material, or of metal, or different, provided that the properties of the selected material are suitable for the intended use of the fastener 106.

As has been described, the fastening system 104 contained a fastener 106 and a cage 102. The fastener 106 is retracted by the cage 102. A sealing element 108 is arranged so that using the fastener 106 places the sealing element 108 in a sealing fit between the cage 102 and the fastener 106. The sealing element 108 is capable of forming a barrier against the penetration of smoke or other expected contaminants.

The fasteners 106, cage 102 and sealing element 108 are made of metal. The sealing element 108 is generally made of a material that is relatively softer than the materials that make up the cage 102, the fastener 106 or other surrounding materials (such as the body in white), such that operating the fastener 106 pushes the sealing element 108 towards another, harder material and causes the sealing element 108 to deform to provide a sealing fit between the parts where the sealing element 108 is located. Suitable materials for the sealing element 108 include copper or aluminum, in places where the fastener 106, cage 102 or body in white are made of steel. Thus, the sealing element 108 is made of a metal with a reduced hardness compared to the metal used to make the fastener and/or the cage. Plastic, rubber or any other material with a low melting point/heat tolerance is not suitable because of the heat generated when welding the cage 102 to the body in white.

The sealing element 108 can also form a seal around an insert 110 that is placed in the fastener 106, so that the seal is formed between the insert 110 and the fastener 106. An insert 110 in this case is any element designed to operate the fastener 106 and form a connection, such as a screw, threaded rod or bolt. FIGS. 1 to 4 illustrate a threadless insert 110 in order to avoid obscuring the figures unnecessarily.

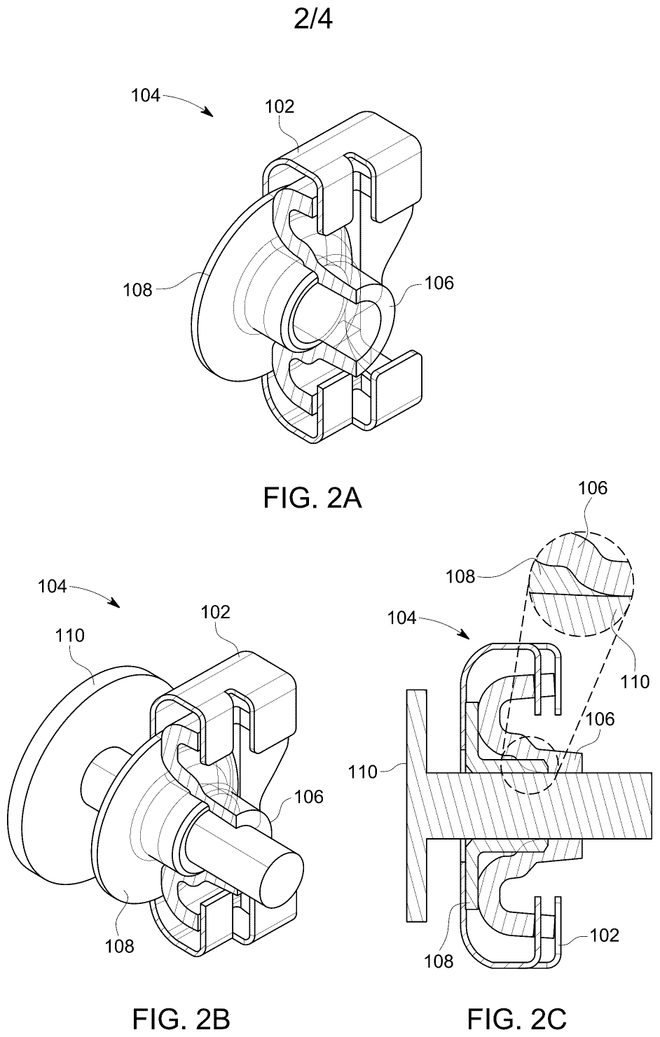

With reference to FIGS. 2a through 2c, a fastening system 104 is provided according to a second aspect, similar to that of FIGS. 1a through 1c, and sharing similar reference numbers for similar parts. More specifically, FIG. 2a illustrates the fastener in accordance with a second aspect, in a partial cross-section, while FIGS. 2b and 2c illustrate, respectively, the fastener with an insert in a partial cross-section and as seen from the side with an insert. The sealing element 108 can be arranged to sealingly interfere with the fastener 106, when the fastener 106 is used to form the barrier. As illustrated in FIGS. 2a through 2c, this can be achieved by means of a sealed interface between the fastener 106 and the insert 110, and by sealing element 108 ductility enabling the sealing element 108 to be drawn and/or pressed between the parts, such as into the matching threads (if any) of the fastener 106 and the insert 110. This interaction can be enhanced by providing the sealing element 108 with a flange that directs the material into a snug fit between the connected parts.

The insert 110 can be self-tapping and the sealing element 108 can be threadless, so that operating the insert 110 with the fastener 106 results in tightly-cooperating threads that prevent the ingress of smoke or other contaminants. In other words, the threads cut into the sealing element 108 also form a seal between the insert 110 and sealing element 108.

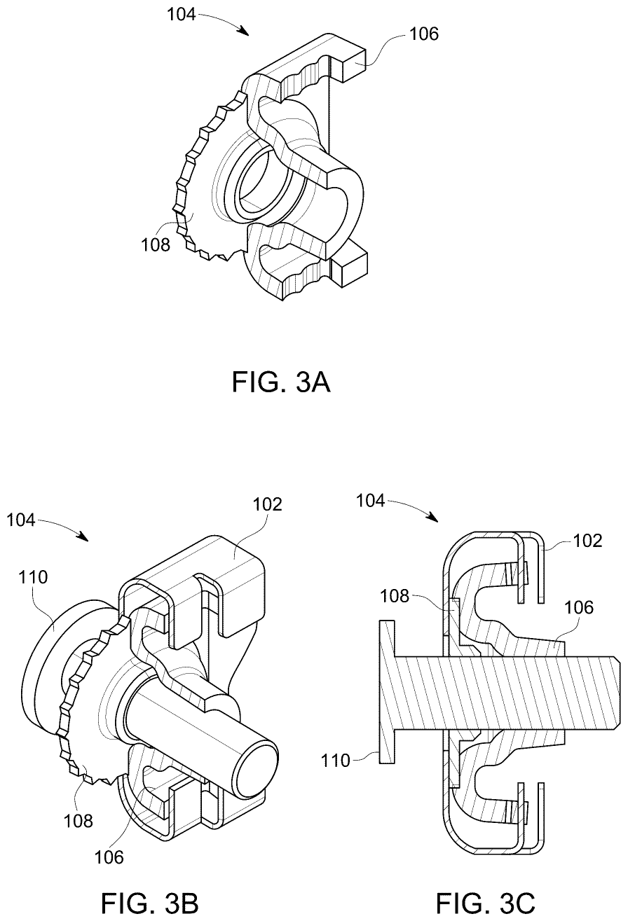

With reference to FIGS. 3a through 3c, a fastening system 104 according to a third aspect, similar to the one in FIGS. 1a through 1c, is illustrated and shares similar reference numbers for similar parts. More specifically, FIG. 3a illustrates the fastener in accordance with a third aspect in a partial cross-section, while FIGS. 3b and 3c illustrate, respectively, the fastener with an insert in a partial cross-section and as seen from the side with an insert. The sealing element 108 is connected to the fastener 106 and/or to the cage 102. Connecting the sealing element 108 to either the fastener 106 or the cage 102 enables easier operation of the fastening system 104, since these parts are kept in a predefined relationship to each other and do not need to be aligned prior to mounting. This connection can be transient or loose, so that the sealing element 108 can be easily detached from the other part. The grip of the other part on the sealing element 108 only needs to be sufficient to enable precise positioning of the insert 110 in the fastener 106 via the sealing element 108. Accordingly, the connection can be created by an adhesive or by pressing the sealing element 108 onto the other part. In the aspect shown in FIGS. 3a through 3c, an interlocking fit is used, and the sealing element 108 is provided with teeth to increase a contact zone between the two parts in order to provide an adequate grip.

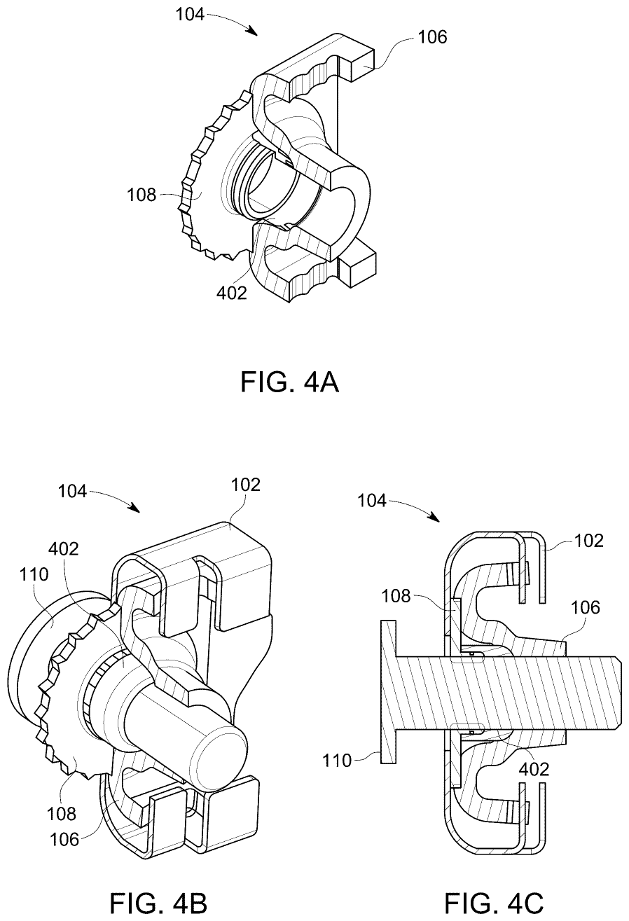

With reference to FIGS. 4a through 4c, a fastening system 104 according to a fourth aspect is provided, similar to that in FIGS. 1a through 1c and sharing similar reference numbers for similar parts. More specifically, FIG. 4a illustrates the fastener in accordance with a fourth aspect, in a partial cross-section, while FIGS. 4b and 4c illustrate, respectively, the fastener with an insert in a partial cross-section and as seen from the side with an insert. The cage 102 is usually the part that undergoes spot welding to the body in white and therefore presents a heat risk for the sealing element 108. Depending on the size of the cage 102 and the ability of the part to dissipate heat as a result of its material properties or design, or otherwise to provide thermal insulation for the sealing element 108 in the cage 102, a soft cap 402 can be provided on the sealing element 108 to provide the seal, or an additional seal, against smoke or contaminants. The soft cap 402 can be made of a sealing material such as rubber, polymer, silicone or the like. The word “cap” does not require the presence of a closed end or a blind bore, but the soft cap 402 can be a sleeve with both ends open. Such a material can have a low heat tolerance, but due to the small amount of this material and to the location of the soft cap 402, it can be arranged so as not to contact the cage 102 and still provide a suitable seal. In FIGS. 4a through 4c, the sealing element 108 comprises a soft cap 402, and the soft cap 402 is located on the sealing element 108 away from the cage 102. Inserting the insert 110 can pierce the soft cap 402 so that the soft cap 402 can provide a sealing fit against the insert 110 and/or between the insert 110 and the fastener 106.

The soft cap 402 can itself ensure a sufficient seal against smoke/contaminant ingress, or can work synergistically with the sealing element 108, which can deform to provide another seal as described previously in this disclosure.

The person skilled in the art will understand that the detailed aspects described above are by way of example only and are not intended to be limiting, and that various changes are possible without departing from the scope of the disclosure as defined in the appended claims. Various changes can be made to the detailed examples described above.

In the description and claims of this specification, the words “comprise” and “contain” and variants thereof mean “including but not limited to” and are not meant for (and do not exclude) other parts, additives, components, integers or steps. In the description and claims of this specification, the singular includes the plural, unless the context requires otherwise. In particular, when the indefinite article is used, the specification should be understood to include the plural as well as the singular, except where the context requires otherwise.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMBERS

102: Cage
104: Fastening System
106: Fastener
108: Sealing element
110: Insert
402: Soft cap

What is claimed is:

1. A fastening system (104) comprising:
a fastener (106)
a cage (102)
in which the fastener (106) is enclosed and held by the cage (102), and
a sealing element (108) arranged so that using the fastener (106) places the sealing element (108) in a sealing area between the cage (102) and the fastener (106).

2. The fastening system (104) according to claim 1, wherein the sealing element (108) also forms a seal around an insert (110) that is placed in the fastener (106).

3. The fastening system (104) according to claim 1, wherein the sealing element (108) sealingly interferes with the fastener (106), when the fastener (106) is used.

4. The fastening system (104) according to claim 2, wherein the sealing element (108) is arranged to sealingly interfere between the fastener (106) and the insert (110).

5. The fastening system (104) according to claim 1, wherein the sealing element (108) comprises a soft cap (402).

6. The fastening system (104) according to claim 5, wherein the soft cap (402) is located on the sealing element (108) away from the cage (102).

7. The fastening system (104) according to claim 1, wherein the sealing element (108) is loosely connected to the cage (102) and/or to the fastener (106).

8. The fastening system (104) according to claim 1, wherein the sealing element (108) is directly connected to the fastener (106) and/or to the cage (102).

9. The fastening system (104) according to claim 1, wherein the fastener (106), the cage (102) and/or the sealing element (108) are respectively made of metal.

10. The fastening system (104) according to claim 9, wherein the sealing element (108) is made of a metal with a reduced hardness compared to the metal used to make the fastener (106) and/or the cage (102).
